(19) United States
(12) Patent Application Publication
(10) Pub. No.: US 2023/0217235 A1
(43) Pub. Date: Jul. 6, 2023

(54) HSS-BASED P-CSCF RESTORATION TRIGGERED BY AS

(71) Applicant: T-Mobile USA, Inc., Bellevue, WA (US)

(72) Inventors: Saqib Badar, Bellevue, WA (US); Subramania Kaushik, Bellevue, WA (US); Nassereddine Sabeur, Bellevue, WA (US); Shujaur Rehman Mufti, Snoqualmie, WA (US); Joel Arends, Renton, WA (US)

(21) Appl. No.: 17/566,128

(22) Filed: Dec. 30, 2021

(51) Int. Cl. H04W 8/04; H04W 8/30; H04W 76/18; H04L 65/10

(52) U.S. Cl. CPC H04W 8/04; H04W 8/30; H04W 76/18; H04L 65/1006; H04W 88/182

(57) ABSTRACT

Described herein are techniques, devices, and systems for using an application server (AS) to trigger home subscriber server (HSS)-based proxy call session control function (P-CSCF) restoration for a user equipment (UE) in order to restore service to the UE via an in-service P-CSCF node. For example, an AS is configured to receive, from a serving CSCF (S-CSCF) node, an indication that a P-CSCF node assigned to a UE is unavailable, and, in response, the AS is configured to send, to a HSS, a request to initiate P-CSCF restoration for the UE. In turn, the HSS or a Unified Data Management (UDM) node is configured to send, to a control node, an indication to perform the P-CSCF restoration for the UE. The disclosed AS-triggered, HSS-based P-CSCF restoration procedure restores service to the UE.

### BACKGROUND

Internet Protocol Multimedia Subsystem (IMS) is an architectural framework defined by the 3rd Generation Partnership Project (3GPP) for delivering Internet Protocol (IP) multimedia to user equipment (UEs) of the IMS network. During a registration procedure for IMS-based services, the UE is assigned a proxy call session control function (P-CSCF) node. The P-CSCF node acts as the ingress and egress point to and from the IMS core with respect to the UE, once registered.

Although today's telecommunications networks are fairly reliable, it is possible for such an assigned P-CSCF node to become unavailable after IMS registration. If a P-CSCF node becomes unavailable, a communication session cannot be established with the UEs assigned to the unavailable P-CSCF node. For example, the UEs will not receive any calls for the duration of the unavailability or until the UEs perform registration.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 is a diagram illustrating example signaling between a UE and various nodes of a telecommunications network, including nodes of an IMS core. FIG. 1 also illustrates a 4^{th} Generation (4G) implementation of an application server (AS)-triggered, home subscriber server (HSS)-based P-CSCF restoration procedure for the UE, according to various embodiments.

FIG. 2 is a diagram illustrating example signaling between a UE and various nodes of a telecommunications network, including nodes of an IMS core. FIG. 2 also illustrates a 5^{th} Generation (5G) implementation of an AS-triggered, HSS-based P-CSCF restoration procedure for the UE, according to various embodiments.

FIG. 3 illustrates a flowchart of an example AS-triggered, HSS-based P-CSCF restoration process, according to various embodiments.

FIG. 4 illustrates a flowchart of an example 4G implementation of an AS-triggered, HSS-based P-CSCF restoration process, according to various embodiments.

FIG. 5 illustrates a flowchart of an example 5G implementation of an AS-triggered, HSS-based P-CSCF restoration process, according to various embodiments.

FIG. 6 is a block diagram of an example IMS node(s) with logic to implement an AS-triggered, HSS-based P-CSCF restoration procedure, according to various embodiments.

### DETAILED DESCRIPTION

Existing P-CSCF restoration procedures are documented in 3GPP Technical Specification (TS) 23.380. TS 23.380 documents two known ways of performing P-CSCF restoration: (i) HSS-based P-CSCF restoration, and (ii) policy and charging rules function (PCRF)-based P-CSCF restoration. In the existing HSS-based P-CSCF restoration procedure, the serving CSCF (S-CSCF) node is configured to send a message (e.g., a Cx Server Assignment Request (SAR) message) directly to the HSS to trigger P-CSCF restoration. However, with the existing HSS-based P-CSCF restoration procedure, if the S-CSCF node happens to be overloaded (e.g., if a processing workload of the S-CSCF node is above a threshold) at a time when a P-CSCF node becomes unavailable, a user may go without service for an extended period of time because the overloaded S-CSCF node may cause a delay in the UE connecting to another P-CSCF node that is available.

Described herein are techniques, devices, and systems for using an AS to trigger HSS-based P-CSCF restoration for a UE in order to restore service to the UE via an in-service P-CSCF node. With the disclosed AS-triggered, HSS-based P-CSCF restoration procedure, an AS is configured to receive, from a S-CSCF node, an indication that a P-CSCF node assigned to a UE is unavailable, and, in response, the AS is configured to send, to a HSS, a request to initiate P-CSCF restoration for the UE. In turn, the HSS or a Unified Data Management (UDM) node is configured to send, to a control node (e.g., a mobility management entity (MME) in a 4G implementation, an access and mobility function (AMF) node or a session management function (SMF) node in a 5G implementation, etc.), an indication to perform the P-CSCF restoration for the UE. In other words, HSS-based P-CSCF restoration is triggered by the AS instead of the S-CSCF node directly contacting the HSS to trigger HSS-based P-CSCF restoration.

In an illustrative example, if a terminating UE is involved in a communication session, and a S-CSCF node that is serving the terminating UE sends, to a first P-CSCF node, a Session Initiation Protocol (SIP) message (e.g., a SIP message using the SIP INVITE method to establish the communication session), and either (i) a timeout occurs or (ii) the S-CSCF node receives an error code from the first P-CSCF node, the S-CSCF node is configured to notify the AS (e.g., a telephony AS (TAS)) by sending, to the AS, a SIP message indicating that the first P-CSCF node is unavailable. Upon receiving this SIP message from the S-CSCF, the AS is configured to send a request (e.g., a user data request (UDR) message) to the HSS requesting the HSS to initiate P-CSCF restoration for the UE. The HSS may then send an acknowledgement (e.g., a user data answer (UDA) message) back to the AS, and the HSS or the UDM may also send an indication to a control node (e.g., a MME, a AMF/SMF, etc.) to perform the P-CSCF restoration for the UE. After the control node receives this indication from the HSS/UDM, one or more procedures are carried out at least in part by the control node and the UE to cause the UE to connect to a second P-CSCF node that is available in order to restore service to the UE (and, hence, to a user of the UE).

Accordingly, the techniques, devices, and systems described herein improve the resiliency of a telecommunications network by leveraging an AS to trigger HSS-based P-CSCF restoration. The P-CSCF restoration is performed in order to move a UE from an unavailable P-CSCF node to an available P-CSCF node. In this way, service for the UE (and, hence, the user thereof) can be restored faster and/or more reliably, as compared to existing P-CSCF restoration procedures, such as the P-CSCF restoration procedures documented in TS 23.380. In general, using an AS to trigger HSS-based P-CSCF restoration facilitates the establishment of subsequent calls for a UE, thereby providing a more stable, resilient telecommunications network, which can be critical in emergency situations.

Furthermore, service can be restored in a selective manner for individual UEs that are currently registered with an unavailable P-CSCF using the techniques, devices, and systems described herein. That is, instead of overloading the network by contemporaneously initiating P-CSCF restoration for upwards of hundreds of thousands of subscribers who are assigned to an unavailable P-CSCF node, the techniques, devices, and systems described herein allow for using an AS to selectively trigger HSS-based P-CSCF restoration for individual UEs. For example, a UE may remain connected to an unavailable P-CSCF node until a S-CSCF node assigned to the UE sends a SIP message to the unavailable P-CSCF node and determines that the P-CSCF node is unavailable (e.g., based on a timeout or an error code received from the unavailable P-CSCF node). This selective triggering of HSS-based P-CSCF restoration conserves bandwidth on the network and it allows for moving users from an unavailable P-CSCF node to an available P-CSCF node in a gradual manner, on-demand. Accordingly, the techniques, devices, and systems described herein may allow one or more devices to conserve resources with respect to processing resources, memory resources, networking resources, power resources, etc., in the various ways described herein.

The techniques, devices, and systems described herein may be particularly beneficial for restoring service to terminating UEs that remain idle while registered for IMS-based services. That is, the disclosed AS-triggered, HSS-based P-CSCF restoration procedures can be carried out “behind the scenes,” unbeknownst to the user of a terminating UE to ensure that the terminating UE is connected to an in-service P-CSCF node. In other words, even when a UE is registered for IMS-based services and remains idle (e.g., if the UE is not being used while being carried in a user's pocket or purse, sitting on a countertop, etc.), the disclosed AS-triggered, HSS-based P-CSCF restoration procedures can be carried out for the idle UE so that calls can be received as soon as possible after detecting that a P-CSCF node assigned to the idle UE has become unavailable. In an illustrative example, if an originating UE is used to call or message a terminating UE, the AS that is involved in the SIP signaling to establish this communication session can trigger HSS-based P-CSCF restoration as soon as the S-CSCF node determines that the P-CSCF node assigned to the terminating UE is unavailable, thereby restoring service to the terminating UE sooner, rather than waiting for a longer period of time (sometimes as long as an hour or more) to lapse before automatically re-registering for IMS-based services. After P-CSCF restoration, the terminating UE is connected to an available P-CSCF node and is thereafter able to receive calls, messages, file transfers, etc.

Also disclosed herein are systems and devices comprising one or more processors and one or more memories, as well as non-transitory computer-readable media storing computer-executable instructions that, when executed, by one or more processors perform various acts and/or processes disclosed herein.

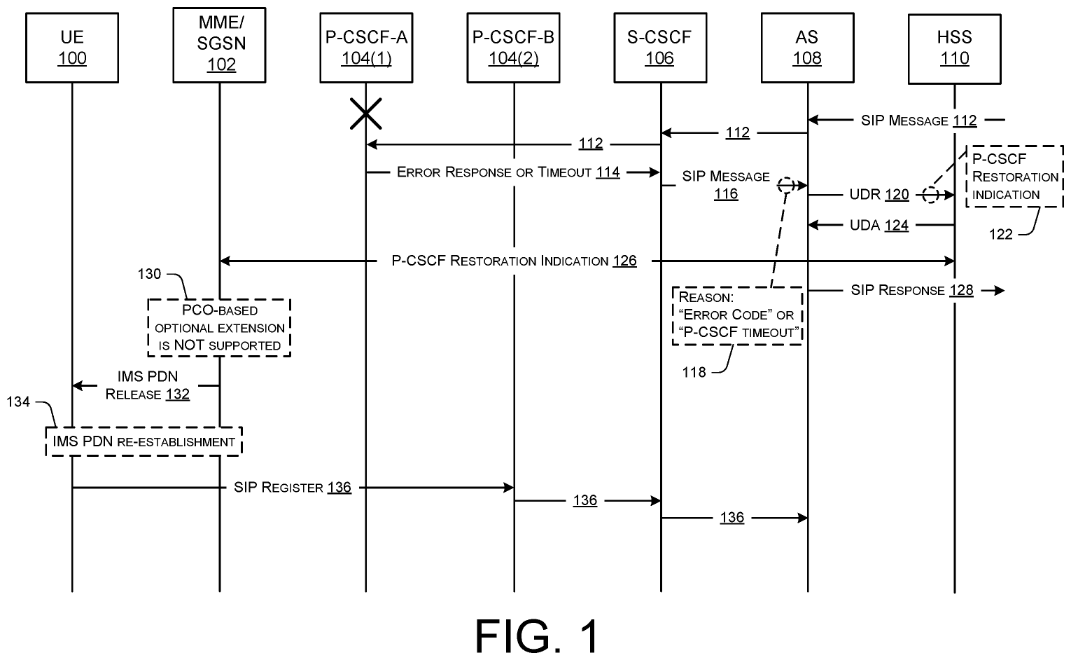

FIG. 1 is a diagram illustrating example signaling between a UE 100 and various nodes (or network elements) of a telecommunications network, including nodes of an IMS core. FIG. 1 also illustrates a 4G implementation of an AS-triggered, HSS-based P-CSCF restoration procedure for the UE 100, according to various embodiments. The UE 100 may be implemented as any suitable type of computing device configured to communicate over a wireless network, including, without limitation, a mobile phone (e.g., a smart phone/handset), a tablet computer, a laptop computer, a portable digital assistant (PDA), a wearable computer (e.g., electronic/smart glasses, a smart watch, fitness trackers, head-mounted display (HMD), etc.), an in-vehicle (e.g., in-car) computer, and/or any similar mobile device, as well as situated computing devices including, without limitation, a television (smart television), set-top-box (STB), desktop computer, and the like. In accordance with various embodiments described herein, the terms “user equipment (UE),” “wireless communication device,” “wireless device,” “communication device,” “mobile device,” “client device,” 'π electronic device,” and “device” may be used interchangeably herein to describe any UE (e.g., the UE 100 of FIG. 1) that is capable of transmitting/receiving data wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), Voice over New Radio (VoNR), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology, including 5G New Radio (NR) network protocols, and/or existing or legacy network technology, such as 2G, 3G, 4G, including circuit-switched networking protocols and/or packet-switched networking protocols.

In general, a user can utilize a UE, such as the UE 100, to communicate with other computing devices of a telecommunications network. FIG. 1 depicts various nodes (or network elements) of a telecommunications network including a MME/Serving GPRS Support Node (SGSN) 102, a first P-CSCF node 104(1) (Labeled “P-CSCF-A” in FIG. 1), a second P-CSCF node 104(2) (Labeled “P-CSCF-B” in FIG. 1), a S-CSCF node 106, an AS 108, and a HSS 110. It is to be appreciated that a telecommunications network can include additional nodes that are not shown in FIG. 1, such as nodes including, without limitation, an interrogating CSCF (I-CSCF) node, an emergency CSCF (E-CSCF) node, a security gateway (SEG), and so on. Furthermore, any of the nodes (or network elements) described herein may be capable of transmitting/receiving data using any suitable communications/data technology, protocol, or standard, including those mentioned herein with respect to a UE for use in transmitting/receiving data.

The nodes 104-110 of FIG. 1 are example nodes of the IMS core (sometimes referred to as the “IMS core network”, the “Core Network (CN),” or the “IM CN Subsystem”). The IMS core permits wireless and wireline devices to access IP multimedia, messaging, and voice applications and services. IMS also allows for peer-to-peer communications, as well as client-to-server communications over an IP-based network. The IMS core may represent any type of SIP-based network that is configured to handle/process SIP signaling packets or messages. SIP is a signaling protocol that can be used to establish, modify, and terminate communication sessions—such as multimedia sessions (e.g., a multimedia telephony call, a text messaging session, a messaging session and/or file transfer using Rich Communication Services (RCS), etc.), a protocol data unit (PDU) sessions, or the like—over packet networks, and to authenticate access to IMS-based services.

The IMS core can be maintained and/or operated by one or more service providers, such as one or more wireless carriers (or “operators”, “telecommunication service providers”, etc.), that provide IMS-based services to users (sometimes called “subscribers”) who are associated with UEs, such as the UE 100. For example, a service provider may offer multimedia telephony services that allow a subscribed user to call or message other users via an IMS core using his/her UE. A user can also utilize an associated UE to receive, provide, or otherwise interact with various different IMS-based services by accessing computing devices of an IMS core. In this manner, a service provider may offer any type of IMS-based service, such as, telephony services, emergency services (e.g., E911), gaming services, instant messaging services, presence services, video conferencing services, social networking and sharing services, location-based services, push-to-talk services, real-time text (RTT) services, RCS, and so on.

The UE 100 of FIG. 1 is configured to utilize various access networks (not shown in FIG. 1), including radio access networks (RANs) and/or radio access technologies (RATs), in order to access one or more of the nodes depicted in FIG. 1. In general, 4G LTE-compliant UEs and 5G NR-compliant UEs are configured to prefer attachment to corresponding networks and/or systems, which offer relatively high data-rate throughput as compared to available legacy or predecessor networks and/or systems. In most UEs, a choice of which protocol to employ depends primarily on what networks and/or systems are available to the UE at the UE's present geographic location. Furthermore, in instances where the preferred network and/or system is unavailable or unusable for any reason, legacy networks, if available, may be used as a fallback protocol. The UE 100 of FIG. 1 can represent a UE with such capabilities to allow for communication over any type of telecommunications network. FIG. 1 is an example of a 4G network and/or system. Accordingly, the UE 100 of FIG. 1 may be at least 4G LTE-compliant, if not 5G NR-compliant with backwards compatibility.

The UE 100 of FIG. 1 may be configured to register for, and thereafter access and utilize, one or more IMS-based services via the IMS core. To this end, the UE 100 may be configured to transmit messages to the IMS core as part of an IMS registration procedure where the UE 100 is requesting to register for an IMS-based service(s). A registration procedure for the UE 100 can involve identifying the first P-CSCF node 104(1) (“P-CSCF-A”) and sending a registration request via a RAN (not shown in FIG. 1) and evolved packet core (EPC) to the first P-CSCF node 104(1) (“P-CSCF-A”). In the example of FIG. 1, it is assumed that the UE 100 has already performed such a registration procedure where the first P-CSCF node 104(1) (“P-CSCF-A”) was identified and assigned to the UE 100. After registration, the first P-CSCF node 104(1) (“P-CSCF-A”) acts as the ingress and egress point to and from the IMS core with respect to the UE 100. The responsibilities of a P-CSCF node 104 may generally include, without limitation, onward routing of registration and session requests to the correct nodes in the network, performing encryption/decryption as a security mechanism for traffic transmitted over the SIP layer, and/or maintaining a secure connection with the UE 100.

FIG. 1 illustrates a failure scenario where the first P-CSCF node 104(1) (“P-CSCF-A”) becomes unavailable after the UE 100 has completed IMS registration with the first P-CSCF node 104(1) (“P-CSCF-A”) being assigned to the UE 100. There can be various reasons why the first P-CSCF node 104(1) (“P-CSCF-A”) becomes unavailable. In one example, the first P-CSCF node 104(1) (“P-CSCF-A”) might have failed (or “gone down”) due to a malfunction of hardware, software, firmware, or a combination thereof. In some scenarios, such a malfunction can render the first P-CSCF node 104(1) (“P-CSCF-A”) unable to communicate with other nodes and/or the UE 100. In other scenarios, the first P-CSCF node 104(1) (“P-CSCF-A”) may be able to communicate with other nodes and/or the UE 100 notwithstanding a malfunction of hardware, software, and/or firmware, but the first P-CSCF node 104(1) (“P-CSCF-A”) may nevertheless be unable to perform one or more functions it is tasked with performing under normal operating conditions. The root causes of these example failure scenarios can vary. In any of the failure scenarios described herein, the first P-CSCF node 104(1) (“P-CSCF-A”) is considered to be “unavailable” (or “out of service”).

In the example of FIG. 1, a user of another UE (not shown in FIG. 1) may attempt to communicate with the user of the UE 100, such as by calling the user, send a text message to the user, starting a chat session with the user, attempting a file transfer to the UE 100, etc. Such an attempt to communicate with the user of the UE 100 may cause an incoming SIP message 112 to be received by the AS 108. The AS 108 can represent a TAS, in one example. In other examples, the AS 108 can represent an AS configured to provide text messaging services, or an AS configured to provide RCS (e.g., chat sessions, file transfers, etc.). Moreover, the SIP message 112 may be associated with any suitable SIP method, depending on the circumstances. For example, if a user of an originating UE (not shown in FIG. 1) is trying to call a user of the UE 100, the SIP message 112 may be transmitted using the SIP INVITE method in order to request establishment of a voice call (e.g., a VoLTE call) with the UE 100. It is to be appreciated, however, that the SIP message 112 may be transmitted using any other suitable type of SIP method, such as a SIP MESSAGE method, to name one alternative example SIP method.

Because the SIP message 112 is destined for the UE 100, the AS 108 may send (e.g., forward) the SIP message 112 to the S-CSCF node 106, and the S-CSCF node 106 may send (e.g., forward) the SIP message 112 to the first P-CSCF node 104(1) (“P-CSCF-A”), as shown in FIG. 1. The S-CSCF node 106 may know to send (e.g., forward) the SIP message 112 to the first P-CSCF node 104(1) based on binding information accessible to the S-CSCF node 106, the binding information indicating that the first P-CSCF node 104(1) (“P-CSCF-A”) is assigned to the registered UE 100. In the example of FIG. 1, the UE 100 is acting as a terminating UE (sometimes referred to herein as a mobile terminating (MT) UE), and the first P-CSCF node 104(1) (“P-CSCF-A”) is acting as a terminating P-CSCF node for the MT UE 100.

In the example of FIG. 1, because the first P-CSCF node 104(1) (“P-CSCF-A”) happens to be unavailable at the time when the S-CSCF node 106 sends (e.g., forwards) the SIP message 112 to the first P-CSCF node 104(1) (“P-CSCF-A”), the S-CSCF node 106 can determine the unavailability of the first P-CSCF node 104(1) (“P-CSCF-A”) in one of multiple ways, denoted by reference numeral 114 in FIG. 1 (“Error Response or Timeout 114”). That is, in at least one example, the S-CSCF node 106 may receive an error code from the first P-CSCF node 104(1) (“P-CSCF-A”) in response to sending the SIP message 112 to the first P-CSCF node 104(1) (“P-CSCF-A”). The error code received by the S-CSCF node 106 at 114 may indicate that the first P-CSCF node 104(1) (“P-CSCF-A”) is unavailable. In some examples, the S-CSCF node 106 may have access to a predefined list of one or more error codes (e.g., 500—Internal Server Error, 503—Service Unavailable, etc.) associated with a P-CSCF restoration procedure. In this manner, if the S-CSCF node 106 receives, from the first P-CSCF node 104(1) (“P-CSCF-A”), an error code that matches one of the error codes in the predefined list of error codes, the S-CSCF node 106 may be configured to send a SIP message 116 to the AS 108, which causes the AS 108 to trigger HSS-based P-CSCF restoration.

In another example, the S-CSCF node 106 may determine the unavailability of the first P-CSCF node 104(1) (“P-CSCF-A”) based on the occurrence of a timeout at 114. That is, the S-CSCF node 106 may send the SIP message 112 and may start a timer that is configured to run for a period of time. If the S-CSCF node 106 does not receive a response from the first P-CSCF node 104(1) (“P-CSCF-A”) prior to a lapse of the period of time, the S-CSCF node 106 may be configured to send a SIP message 116 to the AS 108, which causes the AS 108 to trigger HSS-based P-CSCF restoration.

Accordingly, in some examples, the SIP message 116 sent by the S-CSCF node 106 to the AS 108 may include a “reason 118” to indicate that the first P-CSCF node 104(1) (“P-CSCF-A”) is unavailable. In some examples, the reason 118 may include an error code received by the S-CSCF node 106 from the first P-CSCF node 104(1) (“P-CSCF-A”). In other examples, the reason 118 may include an indication of a timeout having occurred with respect to the first P-CSCF node 104(1) (“P-CSCF-A”). In some examples, a timeout having occurred with respect to the first P-CSCF node 104(1) (“P-CSCF-A”) may be indicated by an error code (e.g., 504—Server Time-out). In other examples, a label, such as “P-CSCF timeout”, may indicate that a timeout has occurred with respect to the first P-CSCF node 104(1) (“P-CSCF-A”).

In FIG. 1, the AS 108 receives the SIP message 116 from the S-CSCF node 106. This SIP message 116 can be received by the AS 108 via an IMS Service Control (ISC) interface. Further, because the AS 108 had previously sent the SIP message 112 to the S-CSCF node 106, the SIP message 116 may represent a “SIP Response” in that both the SIP message 112 and the SIP message 116 pertain to the same communication session involving the UE 100. The AS 108 may be configured to process the SIP message 116 to determine the reason 118 indicating that the first P-CSCF node 104(1) (“P-CSCF-A”) is unavailable. In some examples, the AS 108 may have access to a predefined list of one or more error codes (e.g., 500—Internal Server Error, 503—Service Unavailable, etc.) associated with a P-CSCF restoration procedure in order to distinguish from other scenarios where the AS 108 might receive an error code from the S-CSCF node 106. For example, it may be possible for the AS 108 to receive an error code from the S-CSCF node 106 that does not cause the AS 108 to trigger a HSS-based P-CSCF restoration procedure. This may be the case if, say, the user of the UE 100 did not answer a call or rejected the call. Accordingly, the reason 118 included in the SIP message 116 may include an error code that is specific to a HSS-based P-CSCF restoration procedure in order for the AS 108 to determine, from the reason 118, that HSS-based P-CSCF restoration is to be triggered. FIG. 1 is an example where the SIP message 116 includes a reason 118 that causes the AS 108 to trigger HSS-based P-CSCF restoration.

Accordingly, in response to receiving the SIP message 116 from the S-CSCF node 106 indicating that the first P-CSCF node 104(1) (“P-CSCF-A”) is unavailable, the AS 108 may send, to the HSS 110, a UDR message 120 to trigger (or otherwise initiate) P-CSCF restoration for the UE 100. In the example of FIG. 1, the UDR message 120 may be sent from the AS 108 to the HSS 110 via a Sh interface using Diameter protocol. Diameter protocol is defined by the Internet Engineering Task Force (IETF) in RFC 6733. In some examples, the UDR message 120 includes a P-CSCF Restoration Indication 122. When such a UDR message 120 is received by the HSS 110, the Public User Identity associated with the UE 100 may be unregistered.

In response to receiving the UDR message 120, the HSS 110 may send (e.g., return) to the AS 108, a UDA message 124 as an acknowledgement (e.g., to acknowledge receipt of the UDR message 120). In the example of FIG. 1, the UDA message 124 may be sent from the HSS 110 to the AS 108 via the Sh interface using Diameter protocol. Additionally, or alternatively, the HSS 110 may send a P-CSCF restoration indication 126 to the MME/SGSN 102 in response to receiving the UDR message 120 and/or in response to sending the UDA message 124. Additionally, or alternatively, in response to receiving the UDA message 124, the AS 108 may send a SIP response 128 (e.g., an error response) to the originating side (e.g., destined for an originating UE (not shown in FIG. 1) involved in the communication session with the UE 100).

The indication 126 sent by the HSS 110 to the MME/SGSN 102 may cause the UE 100 to connect to a second P-CSCF node 104(2) (“P-CSCF-B”) that is available. Accordingly, service can be restored to the UE 100 by connecting to the second P-CSCF node 104(2) (“P-CSCF-B”). In some examples, the indication 126 may be sent by the HSS 110 to the MME/SGSN 102 using a S6a/S6d interface and Insert-Subscription-Data-Request (IDR)/Insert-Subscription-Data-Answer (IDA) or a Gr interface and Insert Subscriber Data (ISD) request/answer. In some examples, the MME/SGSN 102 may execute a Protocol Configuration Options (PCO)-based optional extension, if the optional extension is supported by the MME/SGSN 102. In the example of FIG. 1, the MME/SGSN 102 may determine that the PCO-based optional extension is not supported at 130, and the MME/SGSN 102 may release 132 the IMS packet data network (PDN) connection associated with the UE 100. Based on the release 132 of the IMS PDN connection, the UE 100 may activate the IMS PDN connection at 134, identify and select an available P-CSCF node (e.g., the second P-CSCF node 104(2) (“P-CSCF-B”)), and perform the IMS registration procedure, such as by sending a registration request 136 using the SIP REGISTER method to the available, second P-CSCF node 104(2) (“P-CSCF-B”). The registration request 136 may then be forwarded by the second P-CSCF node 104(2) (“P-CSCF-B”) to the S-CSCF node 106, and by the S-CSCF node 106 to the AS 108 to complete IMS registration, whereafter the UE 100 is connected to the second P-CSCF node 104(2) (“P-CSCF-B”), and service is thereby restored for the UE 100.

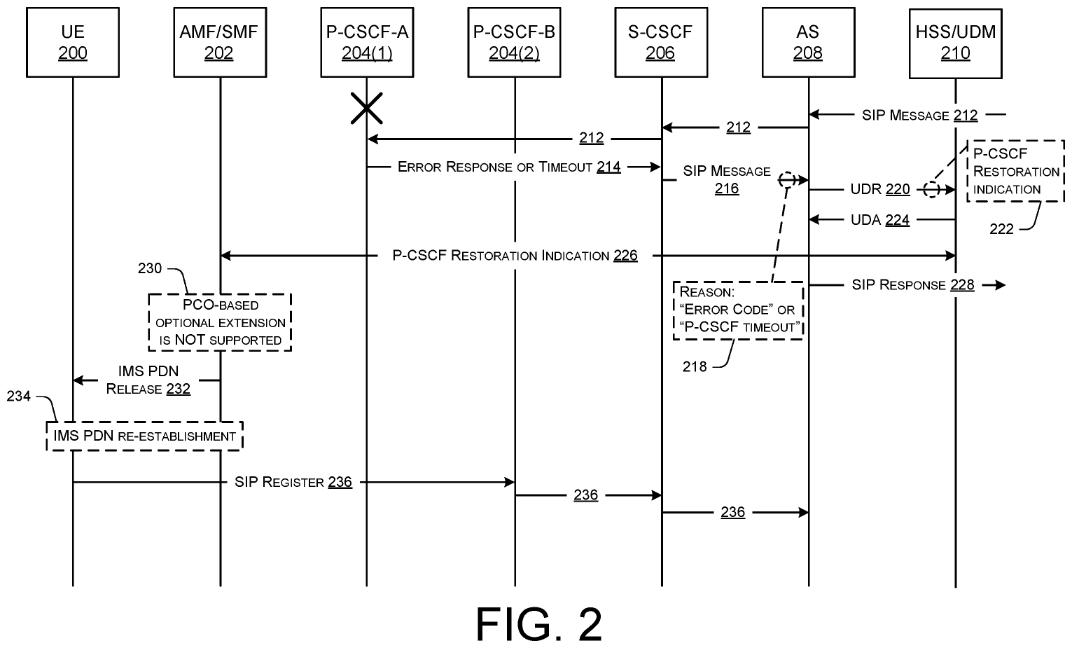

FIG. 2 is a diagram illustrating example signaling between a UE 200 and various nodes (or network elements) of a telecommunications network, including nodes of an IMS core. FIG. 2 also illustrates a 5G implementation of an AS-triggered, HSS-based P-CSCF restoration procedure for the UE 200, according to various embodiments. The UE 200 may represent a UE that is similar to, or the same as, the UE 100 described above.

FIG. 2 depicts various nodes (or network elements) of a telecommunications network including a AMF/SMF node 202, a first P-CSCF node 204(1) (Labeled “P-CSCF-A” in FIG. 2), a second P-CSCF node 204(2) (Labeled “P-CSCF-B” in FIG. 2), a S-CSCF node 206, an AS 208, and a HSS/UDM 210. It is to be appreciated that a telecommunications network can include additional nodes that are not shown in FIG. 2, such as nodes including, without limitation, an I-CSCF node, an E-CSCF node, a SEG, and so on. Furthermore, any of the nodes (or network elements) described herein may be capable of transmitting/receiving data using any suitable communications/data technology, protocol, or standard, including those mentioned herein with respect to a UE for use in transmitting/receiving data.

The nodes 204-210 of FIG. 2 are example nodes of the IMS core, and they may represent nodes that are similar to, or the same as, the nodes 104-110 described above. The UE 200 of FIG. 2 is configured to utilize various access networks (not shown in FIG. 2), including RANs and/or RATs, in order to access one or more of the nodes depicted in FIG. 2. FIG. 2 is an example of a 5G network and/or system. As such, the UE 200 of FIG. 2 can represent a 5G NR-compliant UE with capabilities to allow for communication over any type of telecommunications network, including at least a 5G network and/or system.

The UE 200 of FIG. 2 may be configured to register for, and thereafter access and utilize, one or more IMS-based services via the IMS core. To this end, the UE 200 may be configured to transmit messages to the IMS core as part of an IMS registration procedure where the UE 200 is requesting to register for an IMS-based service(s). A registration procedure for the UE 200 can involve identifying the first P-CSCF node 204(1) (“P-CSCF-A”) and sending a registration request via a RAN (not shown in FIG. 2) and 5G core to the first P-CSCF node 204(1) (“P-CSCF-A”). In the example of FIG. 2, it is assumed that the UE 200 has already performed such a registration procedure where the first P-CSCF node 204(1) (“P-CSCF-A”) was identified and assigned to the UE 200. After registration, the first P-CSCF node 204(1) (“P-CSCF-A”) acts as the ingress and egress point to and from the IMS core with respect to the UE 200.

FIG. 2 illustrates a failure scenario where the first P-CSCF node 204(1) (“P-CSCF-A”) becomes unavailable after the UE 200 has completed IMS registration with the first P-CSCF node 204(1) (“P-CSCF-A”) being assigned to the UE 200. The failure scenario may be similar to, or the same as, the failure scenarios of the first P-CSCF node 104(1) (“P-CSCF-A”) described above with reference to FIG. 1.

In the example of FIG. 2, a user of another UE (not shown in FIG. 2) may attempt to communicate with the user of the UE 200, such as by calling the user, send a text message to the user, starting a chat session with the user, attempting a file transfer to the UE 200, etc. Such an attempt to communicate with the user of the UE 200 may cause an incoming SIP message 212 to be received by the AS 208. The AS 208 can represent a TAS, in one example. In other examples, the AS 208 can represent an AS configured to provide text messaging services, or an AS configured to provide RCS (e.g., chat sessions, file transfers, etc.). Moreover, the SIP message 212 may be associated with any suitable SIP method, depending on the circumstances. For example, if a user of an originating UE (not shown in FIG. 2) is trying to call a user of the UE 200, the SIP message 212 may be transmitted using the SIP INVITE method in order to request establishment of a voice call (e.g., a VoNR call) with the UE 200. It is to be appreciated, however, that the SIP message 212 may be transmitted using any other suitable type of SIP method, such as a SIP MESSAGE method, to name one alternative example SIP method.

Because the SIP message 212 is destined for the UE 200, the AS 208 may send (e.g., forward) the SIP message 212 to the S-CSCF node 206, and the S-CSCF node 206 may send (e.g., forward) the SIP message 212 to the first P-CSCF node 204(1) (“P-CSCF-A”), as shown in FIG. 2. The S-CSCF node 206 may know to send (e.g., forward) the SIP message 212 to the first P-CSCF node 204(1) based on binding information accessible to the S-CSCF node 206, the binding information indicating that the first P-CSCF node 204(1) (“P-CSCF-A”) is assigned to the registered UE 200. In the example of FIG. 2, the UE 200 is acting as a terminating UE (or MT UE), and the first P-CSCF node 204(1) (“P-CSCF-A”) is acting as a terminating P-CSCF node for the MT UE 200.

In the example of FIG. 2, because the first P-CSCF node 204(1) (“P-CSCF-A”) happens to be unavailable at the time when the S-CSCF node 206 sends (e.g., forwards) the SIP message 212 to the first P-CSCF node 204(1) (“P-CSCF-A”), the S-CSCF node 206 can determine the unavailability of the first P-CSCF node 204(1) (“P-CSCF-A”) in one of multiple ways, denoted by reference numeral 214 in FIG. 2 (“Error Response or Timeout 214”). That is, in at least one example, the S-CSCF node 206 may receive an error code from the first P-CSCF node 204(1) (“P-CSCF-A”) in response to sending the SIP message 212 to the first P-CSCF node 204(1) (“P-CSCF-A”). The error code received by the S-CSCF node 206 at 214 may indicate that the first P-CSCF node 204(1) (“P-CSCF-A”) is unavailable. In some examples, the S-CSCF node 206 may have access to a predefined list of one or more error codes (e.g., 500—Internal Server Error, 503—Service Unavailable, etc.) associated with a P-CSCF restoration procedure. In this manner, if the S-CSCF node 206 receives, from the first P-CSCF node 204(1) (“P-CSCF-A”), an error code that matches one of the error codes in the predefined list of error codes, the S-CSCF node 206 may be configured to send a SIP message 216 to the AS 208, which causes the AS 208 to trigger HSS-based P-CSCF restoration.

In another example, the S-CSCF node 206 may determine the unavailability of the first P-CSCF node 204(1) (“P-CSCF-A”) based on the occurrence of a timeout at 214. That is, the S-CSCF node 206 may send the SIP message 212 and may start a timer that is configured to run for a period of time. If the S-CSCF node 206 does not receive a response from the first P-CSCF node 204(1) (“P-CSCF-A”) prior to a lapse of the period of time, the S-CSCF node 206 may be configured to send a SIP message 216 to the AS 208, which causes the AS 208 to trigger HSS-based P-CSCF restoration.

Accordingly, in some examples, the SIP message 216 sent by the S-CSCF node 206 to the AS 208 may include a “reason 218” to indicate that the first P-CSCF node 204(1) (“P-CSCF-A”) is unavailable. In some examples, the reason 218 may include an error code received by the S-CSCF node 206 from the first P-CSCF node 204(1) (“P-CSCF-A”). In other examples, the reason 218 may include an indication of a timeout having occurred with respect to the first P-CSCF node 204(1) (“P-CSCF-A”). In some examples, a timeout having occurred with respect to the first P-CSCF node 204(1) (“P-CSCF-A”) may be indicated by an error code (e.g., 504—Server Time-out). In other examples, a label, such as “P-CSCF timeout”, may indicate that a timeout has occurred with respect to the first P-CSCF node 204(1) (“P-CSCF-A”).

In FIG. 2, the AS 208 receives the SIP message 216 from the S-CSCF node 206. This SIP message 216 can be received by the AS 208 via an ISC interface. Further, because the AS 208 had previously sent the SIP message 212 to the S-CSCF node 206, the SIP message 216 may represent a “SIP Response” in that both the SIP message 212 and the SIP message 216 pertain to the same communication session involving the UE 200. The AS 208 may be configured to process the SIP message 216 to determine the reason 218 indicating that the first P-CSCF node 204(1) (“P-CSCF-A”) is unavailable. In some examples, the AS 208 may have access to a predefined list of one or more error codes (e.g., 500—Internal Server Error, 503—Service Unavailable, etc.) associated with a P-CSCF restoration procedure in order to distinguish from other scenarios where the AS 208 might receive an error code from the S-CSCF node 206. For example, it may be possible for the AS 208 to receive an error code from the S-CSCF node 206 that does not cause the AS 208 to trigger a HSS-based P-CSCF restoration procedure. This may be the case if, say, the user of the UE 200 did not answer a call or rejected the call. Accordingly, the reason 218 included in the SIP message 216 may include an error code that is specific to a HSS-based P-CSCF restoration procedure in order for the AS 208 to determine, from the reason 218, that HSS-based P-CSCF restoration is to be triggered. FIG. 2 is an example where the SIP message 216 includes a reason 218 that causes the AS 208 to trigger HSS-based P-CSCF restoration.

Accordingly, in response to receiving the SIP message 216 from the S-CSCF node 206 indicating that the first P-CSCF node 204(1) (“P-CSCF-A”) is unavailable, the AS 208 may send, to the HSS 210, a UDR message 220 to trigger (or otherwise initiate) P-CSCF restoration for the UE 200. In the example of FIG. 2, the UDR message 220 may be sent from the AS 208 to the HSS 210 via Hypertext Transfer Protocol (HTTP), such as HTTP/2. In some examples, the UDR message 220 includes a P-CSCF Restoration Indication 222. When such a UDR message 220 is received by the HSS 210, the Public User Identity associated with the UE 200 may be unregistered.

In response to receiving the UDR message 220, the HSS 210 may send (e.g., return) to the AS 208, a UDA message 224 as an acknowledgement (e.g., to acknowledge receipt of the UDR message 220). In the example of FIG. 2, the UDA message 224 may be sent from the HSS 210 to the AS 208 via HTTP, such as HTTP/2. Additionally, or alternatively, the UDM 210 may send a P-CSCF restoration indication 226 to the AMF/SMF node 202 in response to receiving the UDR message 220 and/or in response to sending the UDA message 224. Additionally, or alternatively, in response to receiving the UDA message 224, the AS 208 may send a SIP response 228 (e.g., an error response) to the originating side (e.g., destined for an originating UE (not shown in FIG. 2) involved in the communication session with the UE 200).

The indication 226 sent by the UDM 210 to the AMF/SMF node 202 may cause the UE 200 to connect to a second P-CSCF node 204(2) (“P-CSCF-B”) that is available. Accordingly, service can be restored to the UE 200 by connecting to the second P-CSCF node 204(2) (“P-CSCF-B”). In some examples, the indication 226 may be sent by the UDM 210 to the AMF/SMF node 202 via HTTP/HTTP2 as a Nudm_UECM_PCscfRestoration operation. In some examples, the AMF/SMF node 202 may execute a PCO-based optional extension, if the optional extension is supported by the AMF/SMF node 202. In the example of FIG. 2, the AMF/SMF node 202 may determine that the PCO-based optional extension is not supported at 230, and the AMF/SMF node 202 may release 232 the IMS PDN connection associated with the UE 200. Based on the release 232 of the IMS PDN connection, the UE 200 may activate the IMS PDN connection at 234, identify and select an available P-CSCF node (e.g., the second P-CSCF node 204(2) (“P-CSCF-B”)), and perform the IMS registration procedure, such as by sending a registration request 236 using the SIP REGISTER method to the available, second P-CSCF node 204(2) (“P-CSCF-B”). The registration request 236 may then be forwarded by the second P-CSCF node 204(2) (“P-CSCF-B”) to the S-CSCF node 206, and by the S-CSCF node 206 to the AS 208 to complete IMS registration, whereafter the UE 200 is connected to the second P-CSCF node 204(2) (“P-CSCF-B”), and service is thereby restored for the UE 200.

The processes described in this disclosure may be implemented by the architectures described herein, or by other architectures. These processes are illustrated as a collection of blocks in a logical flow graph. Some of the blocks represent operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes. It is understood that the following processes may be implemented on other architectures as well.

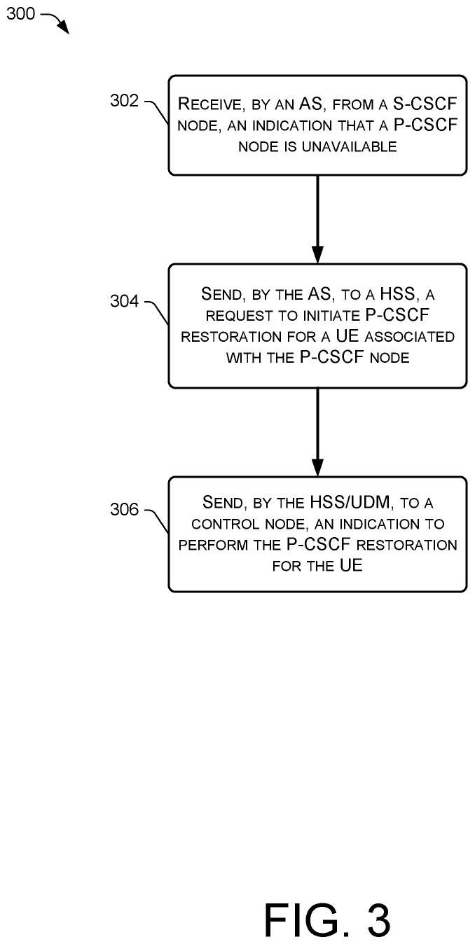

FIG. 3 illustrates a flowchart of an example AS-triggered, HSS-based P-CSCF restoration process 300, according to various embodiments. The process 300 is described with reference to the previous figures. At least part of the process 300 may be performed by an AS 108, 208 and/or by an HSS 110, HSS/UDM 210, and/or by any other suitable computing device(s), as described herein.

At 302, an AS 108, 208 may receive, from a S-CSCF node 106, 206, an indication that a P-CSCF node 104(1), 204(1) is unavailable. The AS 108, 208 may be a TAS, in some examples. In other examples, the AS 108, 208 may be configured to provide text messaging services, RCS, or any other suitable IMS-based service(s). In some examples, the indication received by the AS 108, 208 at block 302 may be in the form of a SIP message 116, 216 that indicates the P-CSCF node 104(1), 204(1) is unavailable. In some examples, the SIP message 116, 216 received by the AS 108, 208 may include a “reason 118, 218” to indicate that the P-CSCF node 104(1), 204(1) is unavailable. In some examples, the reason 118, 218 may include an error code that was previously received by the S-CSCF node 106, 206 from the P-CSCF node 104(1), 204(1). In other examples, the reason 118, 218 may include an indication of a timeout having occurred with respect to the P-CSCF node 104(1), 204(1). In some examples, a timeout having occurred with respect to the P-CSCF node 104(1), 204(1) may be indicated by an error code (e.g., 504—Server Time-out). In other examples, a label, such as “P-CSCF timeout”, may indicate that a timeout has occurred with respect to the P-CSCF node 104(1), 204(1).

At 304, the AS 108, 208 may send, to a HSS 110, 210, a request to initiate P-CSCF restoration for a UE 100, 200 associated with the P-CSCF node 104(1), 204(1). In some examples, the request that is sent to the HSS 110, 210 at block 304 may include a UDR message 120, 220, which may include a P-CSCF Restoration Indication 122, 222, in some examples. In a 4G implementation, the request that is sent to the HSS 110, 210 at block 304 may be sent via a Sh interface using Diameter protocol. In a 5G implementation, the request that is sent to the HSS 110, 210 at block 304 may be sent using HTTP.

At 306, the HSS 110, UDM 210 may send, to a control node, an indication 126, 226 to perform the P-CSCF restoration for the UE 100, 200. The indication 126, 226 sent to the control node at block 306 may cause the UE 100, 200 to connect to a second P-CSCF node 104(2), 204(2) that is available. In a 4G implementation, the control node may be a MME (e.g., a MME/SGSN 102). In a 5G implementation, the control node may be a AMF/SMF node 202.

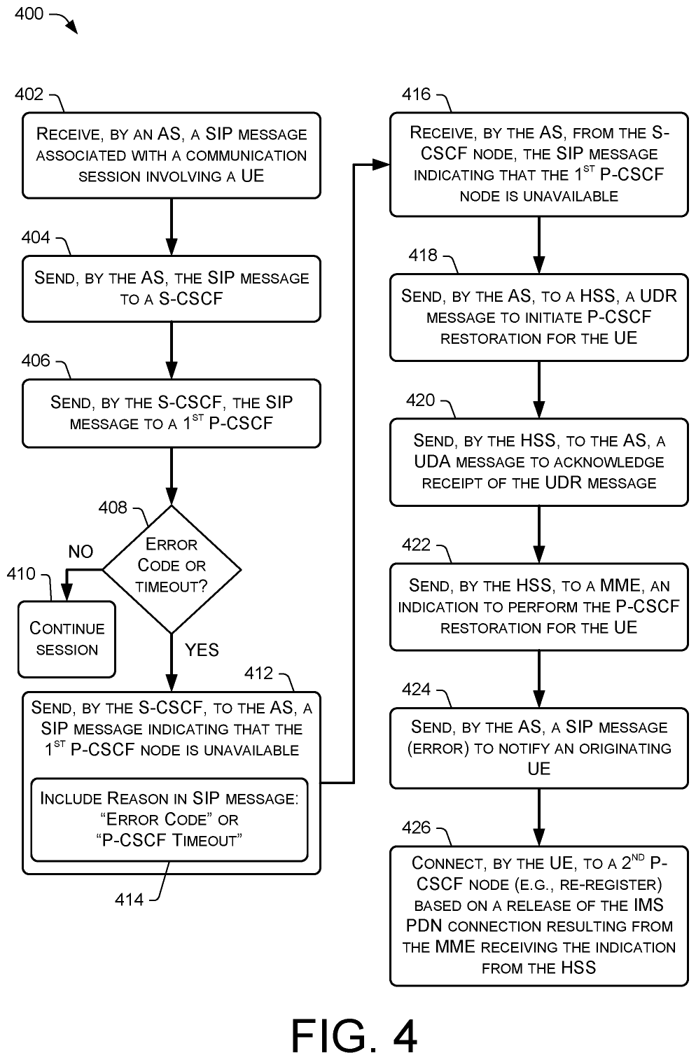

FIG. 4 illustrates a flowchart of an example 4G implementation of an AS-triggered, HSS-based P-CSCF restoration process 400, according to various embodiments. The process 400 is described with reference to the previous figures. At least part of the process 400 may be performed by a UE 100, a MME/SGSN 102, a S-CSCF node 106, an AS 108, and/or an HSS 110, and/or by any other suitable computing device(s), as described herein.

At 402, an AS 108 may receive a first SIP message 112 associated with a communication session involving the UE 100. For example, if a user of an originating UE is trying to call a user of the UE 100, the first SIP message 112 received by the AS 108 at block 402 may have been transmitted using the SIP INVITE method in order to request establishment of a voice call (e.g., a VoLTE call) with the UE 100. It is to be appreciated, however, that the first SIP message 112 received by the AS 108 at block 402 may have been transmitted using any other suitable type of SIP method, such as a SIP MESSAGE method, to name one alternative example SIP method.

At 404, the AS 108 may send the first SIP message 112 to a S-CSCF node 106. At 406, the S-CSCF node 106 may send the first SIP message 112 to a first P-CSCF node 104(1).

At 408, the S-CSCF node 106 may determine, in response to sending the first SIP message 112 to the first P-CSCF node 104(1) at block 406, whether an error code has been received from the first P-CSCF node 104(1) or whether a timeout has occurred with respect to the first P-CSCF node 104(1). That is, in at least one example, the S-CSCF node 106 may receive an error code from the first P-CSCF node 104(1) in response to sending the SIP message 112 to the first P-CSCF node 104(1) at block 406. The error code, if received by the S-CSCF node 106 at block 408, may indicate that the first P-CSCF node 104(1) is unavailable. In some examples, the S-CSCF node 106 may have access to a predefined list of one or more error codes (e.g., 500—Internal Server Error, 503—Service Unavailable, etc.) associated with a P-CSCF restoration procedure. In this manner, the S-CSCF node 106 may be configured to determine, at block 408, whether an error code received from the first P-CSCF node 104(1) matches one of the error codes in the predefined list of error codes. Alternatively, in another example, the S-CSCF node 106 may start a timer that is configured to run for a period of time in response to sending the SIP message 112 to the first P-CSCF node 104(1) at block 406, and the S-CSCF node 106 may determine, at block 408, that a timeout has occurred if a response has not been received from the first P-CSCF node 104(1) prior to a lapse of the period of time. If an expected response is received from the first P-CSCF node 104(1) prior to a lapse of the period of time (i.e., no timeout), and if that response does not include an error code specific to P-CSCF restoration, the process 400 may follow the NO route from block 408 to block 410 where the communication session may continue. For example, if the SIP message 112 is transmitted using the SIP INVITE method to establish a communication session (e.g., a VoLTE call), the communication session may be established, and subsequent SIP signaling to/from the UE 100 may be routed by the available first P-CSCF node 104(1). If, on the other hand, the S-CSCF node 106 determines, in response to sending the first SIP message 112 to the first P-CSCF node 104(1) at block 406, that an error code specific to P-CSCF restoration has been received from the first P-CSCF node 104(1) or that a timeout has occurred with respect to the first P-CSCF node 104(1), the process 400 may follow the YES route from block 408 to block 412.

At 412, the S-CSCF node 106 may send, to the AS 108, a second SIP message 116 that indicates the first P-CSCF node 104(1) is unavailable. In some examples, the S-CSCF node 106 may, at sub-block 414, include a “reason 118” in the SIP message 116 to indicate that the P-CSCF node 104(1) is unavailable. In some examples, the reason 118 may include an error code that was previously received by the S-CSCF node 106 from the first P-CSCF node 104(1) at block 408. In other examples, the reason 118 may include an indication of a timeout having occurred with respect to the first P-CSCF node 104(1). In some examples, a timeout having occurred with respect to the first P-CSCF node 104(1) may be indicated by an error code (e.g., 504—Server Time-out). In other examples, a label, such as “P-CSCF timeout”, may indicate that a timeout has occurred with respect to the first P-CSCF node 104(1).

At 416, the AS 108 may receive, from the S-CSCF node 106, the second SIP message 116 indicating that the first P-CSCF node 104(1) is unavailable. In some examples, the AS 108 is configured to process the second SIP message 116 at block 416 to determine the reason 118 included in the second SIP message 116.

At 418, the AS 108 may send, to a HSS 110, a UDR message 120 to initiate P-CSCF restoration for the UE 100 associated with the P-CSCF node 104(1). In some examples, the UDR message 120 may include a P-CSCF Restoration Indication 122. In some example, the UDR message 120 that is sent to the HSS 110 at block 418 may be sent via a Sh interface using Diameter protocol.

At 420, the HSS 110 may send, to the AS 108, a UDA message 124 to acknowledge receipt of the UDR message 120. In some example, the UDA message 124 that is sent to the AS 108 at block 420 may be sent via the Sh interface using Diameter protocol.

At 422, the HSS 110 may send, to a MME (e.g., MME/SGSN 102), an indication 126 to perform the P-CSCF restoration for the UE 100. The indication 126 sent to the MME (e.g., MME/SGSN 102) at block 422 may cause the UE 100 to connect to a second P-CSCF node 104(2) that is available. In some examples, the indication 126 may be sent by the HSS 110 to the MME (e.g., MME/SGSN 102) at block 422 using a S6a/S6d interface and IDR/IDA or a Gr interface and ISD request/answer.

At 424, the AS 108 may send a SIP response 128 (e.g., an error response) to the originating side (e.g., destined for an originating UE involved in the communication session with the UE 100). The SIP response 128 sent at block 424 may be to notify an originating UE of the unavailability of the first P-CSCF node 104(1) and/or that P-CSCF restoration has been triggered for the UE 100, which may be a MT UE, in this example.

At 426, the UE 100 may connect to a second P-CSCF node 104(2) that is available. For example, based on a release 132 of the IMS PDN connection resulting from the MME (e.g., MME/SGSN 102) receiving the indication 126 from the HSS 110, the UE 100 may activate the IMS PDN connection (See 134 in FIG. 1), identify and select the second P-CSCF node 104(2) as an available P-CSCF node, and perform the IMS registration procedure, such as by sending a registration request 136 using the SIP REGISTER method to the available, second P-CSCF node 104(2) at block 426.

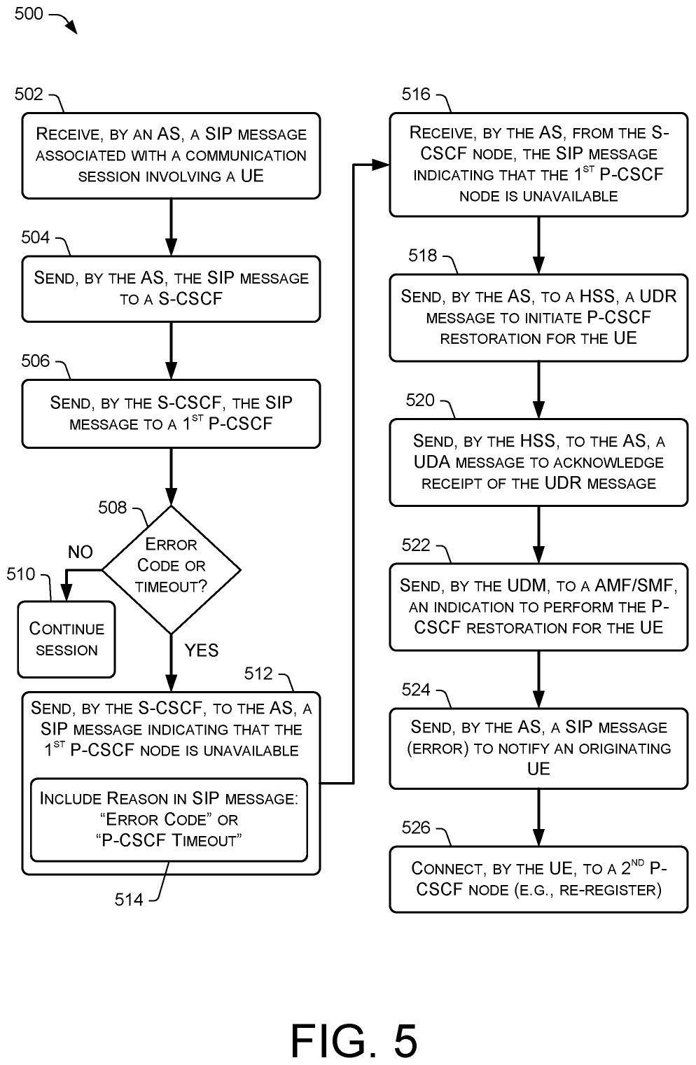

FIG. 5 illustrates a flowchart of an example 5G implementation of an AS-triggered, HSS-based P-CSCF restoration process 500, according to various embodiments. The process 500 is described with reference to the previous figures. At least part of the process 500 may be performed by a UE 200, a AMF/SMF 202, a S-CSCF node 206, an AS 208, and/or an HSS/UDM 210, and/or by any other suitable computing device(s), as described herein.

At 502, an AS 208 may receive a first SIP message 212 associated with a communication session involving the UE 200. For example, if a user of an originating UE is trying to call a user of the UE 200, the first SIP message 212 received by the AS 208 at block 502 may have been transmitted using the SIP INVITE method in order to request establishment of a voice call (e.g., a VoNR call) with the UE 200. It is to be appreciated, however, that the first SIP message 212 received by the AS 208 at block 502 may have been transmitted using any other suitable type of SIP method, such as a SIP MESSAGE method, to name one alternative example SIP method.

At 504, the AS 208 may send the first SIP message 212 to a S-CSCF node 206. At 506, the S-CSCF node 206 may send the first SIP message 212 to a first P-CSCF node 204(1).

At 508, the S-CSCF node 206 may determine, in response to sending the first SIP message 212 to the first P-CSCF node 204(1) at block 506, whether an error code has been received from the first P-CSCF node 204(1) or whether a timeout has occurred with respect to the first P-CSCF node 204(1). That is, in at least one example, the S-CSCF node 206 may receive an error code from the first P-CSCF node 204(1) in response to sending the SIP message 212 to the first P-CSCF node 204(1) at block 506. The error code, if received by the S-CSCF node 206 at block 508, may indicate that the first P-CSCF node 204(1) is unavailable. In some examples, the S-CSCF node 206 may have access to a predefined list of one or more error codes (e.g., 500—Internal Server Error, 503—Service Unavailable, etc.) associated with a P-CSCF restoration procedure. In this manner, the S-CSCF node 206 may be configured to determine, at block 508, whether an error code received from the first P-CSCF node 204(1) matches one of the error codes in the predefined list of error codes. Alternatively, in another example, the S-CSCF node 206 may start a timer that is configured to run for a period of time in response to sending the SIP message 212 to the first P-CSCF node 204(1) at block 506, and the S-CSCF node 206 may determine, at block 508, that a timeout has occurred if a response has not been received from the first P-CSCF node 204(1) prior to a lapse of the period of time. If an expected response is received from the first P-CSCF node 204(1) prior to a lapse of the period of time (i.e., no timeout), and if that response does not include an error code specific to P-CSCF restoration, the process 500 may follow the NO route from block 508 to block 510 where the communication session may continue. For example, if the SIP message 212 is transmitted using the SIP INVITE method to establish a communication session (e.g., a VoNR call), the communication session may be established, and subsequent SIP signaling to/from the UE 200 may be routed by the available first P-CSCF node 204(1). If, on the other hand, the S-CSCF node 206 determines, in response to sending the first SIP message 212 to the first P-CSCF node 204(1) at block 506, that an error code specific to P-CSCF restoration has been received from the first P-CSCF node 204(1) or that a timeout has occurred with respect to the first P-CSCF node 204(1), the process 500 may follow the YES route from block 508 to block 512.

At 512, the S-CSCF node 206 may send, to the AS 208, a second SIP message 216 that indicates the first P-CSCF node 204(1) is unavailable. In some examples, the S-CSCF node 206 may, at sub-block 514, include a “reason 218” in the SIP message 216 to indicate that the P-CSCF node 204(1) is unavailable. In some examples, the reason 218 may include an error code that was previously received by the S-CSCF node 206 from the first P-CSCF node 204(1) at block 508. In other examples, the reason 218 may include an indication of a timeout having occurred with respect to the first P-CSCF node 204(1). In some examples, a timeout having occurred with respect to the first P-CSCF node 204(1) may be indicated by an error code (e.g., 504—Server Time-out). In other examples, a label, such as “P-CSCF timeout”, may indicate that a timeout has occurred with respect to the first P-CSCF node 204(1).

At 516, the AS 208 may receive, from the S-CSCF node 206, the second SIP message 216 indicating that the first P-CSCF node 204(1) is unavailable. In some examples, the AS 208 is configured to process the second SIP message 216 at block 516 to determine the reason 218 included in the second SIP message 216.

At 518, the AS 208 may send, to a HSS 210, a UDR message 220 to initiate P-CSCF restoration for the UE 200 associated with the P-CSCF node 204(1). In some examples, the UDR message 220 may include a P-CSCF Restoration Indication 222. In some example, the UDR message 220 that is sent to the HSS 210 at block 518 may be sent via HTTP, such as HTTP/2.

At 520, the HSS 210 may send, to the AS 208, a UDA message 224 to acknowledge receipt of the UDR message 220. In some example, the UDA message 224 that is sent to the AS 208 at block 520 may be sent via HTTP, such as HTTP/2.

At 522, the UDM 210 may send, to a AMF/SMF node 202, an indication 226 to perform the P-CSCF restoration for the UE 200. The indication 226 sent to the AMF/SMF node 202 at block 522 may cause the UE 200 to connect to a second P-CSCF node 204(2) that is available. In some examples, the indication 226 may be sent by the UDM 210 to the AMF/SMF node 202 at block 522 using HTTP as a Nudm_UECM_PCscfRestoration operation.

At 524, the AS 208 may send a SIP response 228 (e.g., an error response) to the originating side (e.g., destined for an originating UE involved in the communication session with the UE 200). The SIP response 228 sent at block 524 may be to notify an originating UE of the unavailability of the first P-CSCF node 204(1) and/or that P-CSCF restoration has been triggered for the UE 200, which may be a MT UE, in this example.

At 526, the UE 200 may connect to a second P-CSCF node 204(2) that is available. For example, based on a release 232 of the IMS PDN connection resulting from the AMF/SMF 202 receiving the indication 226 from the UDM 210, the UE 200 may activate the IMS PDN connection (See 234 in FIG. 2), identify and select the second P-CSCF node 204(2) as an available P-CSCF node, and perform the IMS registration procedure, such as by sending a registration request 236 using the SIP REGISTER method to the available, second P-CSCF node 204(2) at block 526.

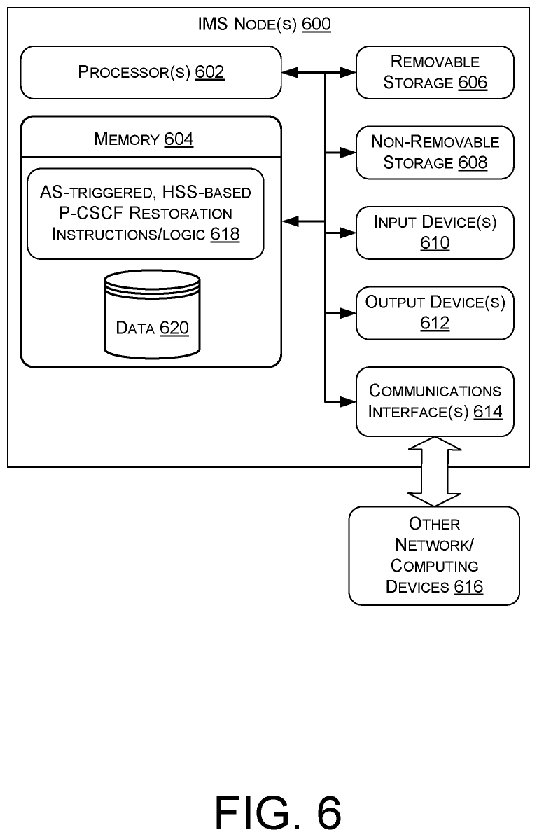

FIG. 6 is a block diagram of an example IMS node(s) 600 with logic 618 to implement an AS-triggered, HSS-based P-CSCF restoration procedure, according to various embodiments. The IMS node(s) 600 may be representative of an individual node (or network element) or multiple nodes (or network elements) of a telecommunications network. In an example, the IMS node(s) 600 may represent multiple nodes including a S-CSCF node 106, 206, an AS 108, 208, and/or a HSS 110, HSS/UDM 210, as described herein.

As shown, the IMS node(s) 600 may include one or more processors 602 and one or more forms of computer-readable memory 604. The IMS node(s) 600 may also include additional storage devices. Such additional storage may include removable storage 606 and/or non-removable storage 608.

The IMS node(s) 600 may further include input devices 610 (e.g., a touch screen, keypad, keyboard, mouse, pointer, microphone, etc.) and output devices 612 (e.g., a display, printer, speaker, etc.) communicatively coupled to the processor(s) 602 and the computer-readable memory 604. The IMS node(s) 600 may further include communications interface(s) 614 that allow the IMS node(s) 600 to communicate with other computing devices 616 (e.g., other nodes, a UE(s), etc.) such as via a network. The communications interface(s) 614 may facilitate transmitting and receiving wired and/or wireless signals over any suitable communications/data technology, standard, or protocol, as described herein.

In various embodiments, the computer-readable memory 604 comprises non-transitory computer-readable memory 604 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 604 may also be described as computer storage media and may include volatile and nonvolatile, removable and non-removable media implemented in any method or technology for storage of information, such as computer readable instructions, data structures, program modules, or other data. Computer-readable memory 604, removable storage 606 and non-removable storage 608 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the IMS node(s) 600. Any such computer-readable storage media may be part of the IMS node(s) 600.

The memory 604 can include logic 618 (i.e., computer-executable instructions that, when executed, by the processor(s) 602, perform the various acts and/or processes disclosed herein) to implement an AS-triggered, HSS-based P-CSCF restoration procedure, according to various embodiments. For example, the logic 618 is configured to carry out the process 300, 400, and/or 500, as described herein. The memory 604 can further be used to store data 620, which may be used to implement an AS-triggered, HSS-based P-CSCF restoration procedure, as described herein. In one example, the data 620 may include a predefined list of one or more error codes (e.g., 500—Internal Server Error, 503—Service Unavailable, etc.) associated with a P-CSCF restoration procedure.

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

We claim:

1. A method comprising:
sending, by a telephony application server (TAS), and to a serving call session control function (S-CSCF) node, a first Session Initiation Protocol (SIP) message associated with a communication session involving a user equipment (UE);
receiving, by the TAS, and from the S-CSCF node, a second SIP message that indicates a first proxy call session control function (P-CSCF) node assigned to the UE is unavailable;
sending, by the TAS, and to a home subscriber server (HSS), a user data request (UDR) message to initiate P-CSCF restoration for the UE; and
sending, by the HSS or a Unified Data Management (UDM) node, and to a control node, an indication to perform the P-CSCF restoration for the UE, the indication causing the UE to connect to a second P-CSCF node that is available.

2. The method of claim 1, further comprising sending, by the HSS, and to the TAS, a user data answer (UDA) message to acknowledge receipt of the UDR message.

3. The method of claim 1, wherein the control node comprises at least one of:
a mobility management entity; or
a session management function (SMF) node.

4. The method of claim 3, wherein the second SIP message includes at least one of:
an error code received by the S-CSCF node from the first P-CSCF node, the error code indicative of the first P-CSCF node being unavailable; or
an indication of a timeout having occurred with respect to the first P-CSCF node, the timeout indicative of the first P-CSCF node being unavailable.

5. A method comprising:
receiving, by an application server (AS), and from a serving call session control function (S-CSCF) node, an indication that a proxy call session control function (P-CSCF) node is unavailable;
sending, by the AS, and to a home subscriber server (HSS), a request to initiate P-CSCF restoration for a user equipment (UE) associated with the P-CSCF node; and
sending, by the HSS or a Unified Data Management (UDM) node, and to a control node, an indication to perform the P-CSCF restoration for the UE.

6. The method of claim 5, wherein the request that is sent to the HSS to initiate the P-CSCF restoration for the UE comprises a user data request (UDR) message.

7. The method of claim 6, further comprising sending, by the HSS, and to the AS, a user data answer (UDA) message to acknowledge receipt of the UDR message.

8. The method of claim 5, wherein:
the control node comprises a mobility management entity; and
the request that is sent to the HSS to initiate the P-CSCF restoration for the UE is sent via a Sh interface using Diameter protocol.

9. The method of claim 5, wherein the control node comprises at least one of an access and mobility function (AMF) node or a session management function (SMF) node.

10. The method of claim 5, wherein the indication sent to the control node causes the UE to connect to a second P-CSCF node that is available.

11. The method of claim 5, further comprising:
sending, by the AS, and to the S-CSCF node, a first Session Initiation Protocol (SIP) message associated with a communication session involving the UE,
wherein the receiving of the indication from the S-CSCF node comprises receiving a second SIP message in response to the sending of the first SIP message.

12. The method of claim 5, further comprising:
sending, by the S-CSCF node, and to the P-CSCF node, a first Session Initiation Protocol (SIP) message associated with a communication session involving the UE,
wherein the receiving of the indication from the S-CSCF node comprises receiving a second SIP message including at least one of:
an error code received by the S-CSCF node in response to the sending of the first SIP message, the error code indicative of the P-CSCF node being unavailable; or
an indication of a timeout having occurred with respect to the P-CSCF node in response to the sending of the first SIP message.

13. A system comprising:
an application server (AS) configured to:
receive, from a serving call session control function (S-CSCF) node, an indication that a proxy call session control function (P-CSCF) node is unavailable; and
send, to a home subscriber server (HSS), a request to initiate P-CSCF restoration for a user equipment (UE) associated with the P-CSCF node; and
the HSS or a Unified Data Management (UDM) node configured to send an indication to a control node to perform the P-CSCF restoration for the UE.

14. The system of claim 13, wherein the request that is sent to the HSS to initiate the P-CSCF restoration for the UE comprises a user data request (UDR) message.

15. The system of claim 14, wherein the HSS is further configured to send, to the AS, a user data answer (UDA) message to acknowledge receipt of the UDR message.

16. The system of claim 13, wherein:
the control node comprises a mobility management entity; and
the request that is sent to the HSS to initiate the P-CSCF restoration for the UE is sent via a Sh interface using Diameter protocol.

17. The system of claim 13, wherein the control node comprises at least one of an access and mobility function (AMF) node or a session management function (SMF) node.

18. The system of claim 13, wherein the indication sent to the control node causes the UE to connect to a second P-CSCF node that is available.

19. The system of claim 13, wherein the AS comprises at least one of:
a telephony AS (TAS);
an AS configured to provide text messaging services; or
an AS configured to provide Rich Communication Services (RCS).

20. The system of claim 13, further comprising the S-CSCF node configured to:
send, to the P-CSCF node, a first Session Initiation Protocol (SIP) message associated with a communication session involving the UE,
wherein the AS is configured to receive the indication from the S-CSCF node as a second SIP message including at least one of:
an error code received by the S-CSCF node in response to the S-CSCF node sending the first SIP message, the error code indicative of the P-CSCF node being unavailable; or
an indication of a timeout having occurred with respect to the P-CSCF node in response to the S-CSCF node sending of the first SIP message.
